(19) United States
(12) Patent Application Publication
(10) Pub. No.: US 2015/0192264 A1
(43) Pub. Date: Jul. 9, 2015

(54) LIGHTING UNIT FOR A HEADLIGHT

(71) Applicant: ZIZALA LICHTSYSTEME GMBH, Wieselburg (AT)

(72) Inventors: Andreas Holzl, Wieselburg (AT); Markus Datzreiter, Sausenstein (AT); Irmgard Krenn, Purgstall/Erlauf (AT); Gerhard Honauer, Wolfpassing (AT)

(73) Assignee: ZIZALA LICHTSYSTEME GMBH, Wieselburg (AT)

(21) Appl. No.: 14/415,362

(22) PCT Filed: Jun. 26, 2013
(86) PCT No.: PCT/AT2013/050130

§ 371 Date: Jan. 16, 2015

(30) Foreign Application Priority Data
Jul. 18, 2012 (AT) A 50284/2012

(51) Int. Cl. F21S 8/10

(52) U.S. Cl. CPC F21S 48/1241; F21S 48/115

(57) ABSTRACT

In a lighting unit (1) for a headlight, in particular a vehicle headlight, consisting of a plurality of light sources (2) and a light-guiding unit (3) having a plurality of light guides (6), each light guide (6) is assigned a light source (2) and the light-guiding unit (3) consists of at least two interconnectable parts (4, 5), wherein a light-source-side part (4) of the light-guiding unit (3) is arranged in the emission direction of the light-guiding unit (3) between the light sources (2) and an emission-side part (5) of the light-guiding unit (3).

The invention relates to a lighting unit for a headlight, in particular a vehicle headlight, consisting of a plurality of light sources and a light-guiding unit having a plurality of light guides.

Lighting units of this type are usual in automotive engineering and are used to project glare-free main beam in that the light, which is generally emitted from a plurality of artificial light sources, from a suitable plurality of light guides arranged side by side is bundled in the emission direction. The light guides have a relatively small cross section and therefore emit the light of the individual light sources assigned to each light guide in a very concentrated manner in the emission direction. In AT 510 437 A4, a light module is disclosed in this context, which has a light guide in the form of an optical waveguide, referred to there as a light tunnel, and also a plurality of light sources.

Within the scope of the invention, preferred light sources in particular are light-emitting diodes (LEDs), which are characterised by a high light output with a very small overall size. For the specified application, conventional LEDs have edge lengths in the range of a millimetre and less and are arranged directly side by side in a matrix, that is to say in groups on a common board, wherein the outer shape of this matrix or groups corresponds to the light exposure that is to be projected. Since the light guides in the light-guiding unit are also arranged directly side by side in order to generate a homogeneous light exposure with a given size of the individual light sources, the walls between the individual light guides, which for example are formed as reflectors, are necessarily very thin. This leads to an increased effort when manufacturing the light-guiding units, which generally all have to be produced by injection moulding. Furthermore, with thin walls between the light guides, the heat input of the used light sources poses a problem, in particular when, in the case of injection moulded parts, the forming temperature of the used thermoplastic is reached, or the used material sustains thermal damage otherwise. A further disadvantage of light-guiding units of this type lies in the fact that, with the small cross sections of the light guides, the reflector surfaces can no longer be uniformly coated reliably, since the aluminium vapour used to apply the coating cannot be distributed into the entire depth of the light guides when it vaporises.

The object of the present invention is therefore to improve a lighting unit of the type mentioned in the introduction, in such a way that the mentioned advantages are avoided.

This object is achieved in accordance with the invention in that each light guide is assigned a light source and the light-guiding unit consists of at least two interconnectable parts, and a light-source-side part of the light-guiding unit is arranged in the emission direction of the light-guiding unit between the light sources and an emission-side part of the light-guiding unit. In the case of the lighting unit according to the invention, the light-guiding unit thus consists of at least two parts, which are arranged such that the light-guiding unit is divided at least into two parts transversely to the light emission direction of the light-guiding unit. The light guides are thus also divided into two along the length thereof, such that shorter portions of the light guides can be cast during production. In other words, this means that the respective light guides are arranged both in the light-source-side part of the light-guiding unit and in the emission-side part of the light-guiding unit. This reduces the risk of faulty casting and allows, for the different parts of the light-guiding unit, the use of materials that are optimised as required in terms of the flow properties thereof and/or that can be selected in terms of the heat resistance thereof.

With a given geometry of the light guides, this enables an increased heat resistance of the parts of the light-guiding unit facing the light sources with a relatively low production outlay. In this context, the light-source-side part of the light-guiding unit directly adjoins the light sources in accordance with a preferred embodiment of the present invention. This leads to a more or less complete emission of the light of the light sources in the light guides, whereby an optimised light yield is attained.

The light-source-side part of the light-guiding unit is preferably manufactured from a material that is more heat resistant than the emission-side part of the light-guiding unit. The heat-resistant material in this case may be a particularly heat-resistant plastic, wherein thermosets can also be processed. In addition, it is also conceivable to fabricate the light-source-side part of the light-guiding unit from ceramic, from metal or from mineral glass.

The high flexibility in terms of the choice of the materials, however, can also be used for the emission-side part of the light-guiding unit. In accordance with a preferred embodiment, the emission-side part of the light-guiding unit is therefore fabricated from a more flowable thermoplastic than the light-source side part of the light-guiding unit. Particularly flowable thermoplastics are generally less temperature-resistant than more viscous materials, but the special embodiment of the light-guiding unit in accordance with the present invention allows the heat of the light sources to be received by the light-source-side part of the light-guiding unit and to dissipate thereover, such that no critical temperatures occur on the emission side.

In order to optimise the performance of the light-guiding unit, reflector surfaces of the light guides are preferably coated in a reflecting manner, in particular with aluminium. Reflector surfaces are usually coated by vapour deposition, wherein the division of the light-guiding unit in accordance with the invention is also advantageous here compared with the prior art in terms of a most uniform coating possible of the reflector surfaces, since the aluminium vapour penetrates easily into the divided and therefore relatively short light guides in the light-source-side part and in the emission-side part of the light-guiding unit.

In order to scatter as little light as possible at the partition surfaces between the parts of the light-guiding unit, through which the light guides pass in accordance with the invention, which would reduce the light output of the lighting unit, the light-source-side part of the light-guiding unit and the emission-side part of the light-guiding unit have fastening means for fastening the two parts in the light-guiding unit transversely to the emission direction in the relative position of said two parts, in accordance with a preferred embodiment of the present invention. In this way, it can thus be ensured, already during construction and during casting or other type of fabrication of the parts of the light-guiding unit, that the parts of the light-guiding unit can be reliably assembled such that the reflector surfaces rest against one another flushly and the light guides, where possible, in the interior thereof thus have no edges or steps, at which the light of the light sources is scattered or blocked. In accordance with a preferred embodiment of the present invention, the light-source-side part of the light-guiding unit has referencing pins and the emission-side part of the light-guiding unit has reference bores assigned to said referencing pins. The referencing pins and the corresponding reference bores additionally ensure an aligned orientation of the two parts of the light-guiding unit relative to one another. In the sense of the present invention, kinematic reversals of this principle are also to be included by this wording.

In order to be able to optimally utilise the advantages already described in terms of the injection moulding and in terms of the coating of the light guides for both parts of the light-guiding unit, the invention is preferably developed to the extent that the light-source-side part of the light-guiding unit and emission-side part of the light-guiding unit are fastened, in terms of the position thereof relative to one another, at curved surfaces corresponding to one another. The light guides in the light-guiding unit have different depths, such that the light decoupling surfaces of the individual light guides are arranged in a curved plane, as will be explained in greater detail further below. The differences in depth can be divided in this preferred embodiment of the invention between the two parts of the light-guiding unit, such that minimal depths are consequently cast in each case and have to be coated.

In accordance with an alternative according to the invention, the emission-side part of the light-guiding unit has a plurality of optical waveguides. An optical waveguide in the sense of the present invention is understood to be a structure in which incident light on the one hand is reflected by total reflection at the walls and in which on the other hand the light is diffracted relative to the vertical of the optical waveguide. In the present case, the optical waveguide is used to collect the light from the light guides and to emit said light in the direction of an optical system, possibly arranged downstream, for example in the form of a lens. Here, the division according to the invention of the light-guiding unit has proven to be advantageous when the material of the optical waveguide is sensitive with respect to heat. In this context it is preferable for the optical waveguide to be fabricated from a transparent plastic. The use of costly glass can thus be spared, since the heat input in the optical waveguide can be kept low accordingly with the lighting unit according to the invention.

Alternatively or additionally, however, the light-source-side of the light-guiding unit may also have a plurality of optical waveguides in accordance with the invention. This can be easily implemented with the present invention depending on the optical objective, provided the inflow of heat from the light sources into the light-source-side part of the light-guiding unit is not too great.

Each optical waveguide on the emission-side part of the light-guiding unit can preferably be assigned to a light guide, in particular a reflector on the light-source-side part of the light-guiding unit, whereby the light can be forwarded in an optimised manner from each of the light guides. For manufacturing reasons, it may be necessary here to combine the optical waveguides assigned to the light guides on the emission side to form a common emission-side end plate. The light decoupling surfaces of the individual optical waveguides in this case lie on the emission-side surface of the emission-side end plate. The emission-side surface of the end plate is curved and follows the image field curvature of the downstream lens, such that all light decoupling surfaces of the individual light guides can be projected sharply by the lens onto the road.

A light-source-side surface of the light-source-side part of the light-guiding unit is preferably coated with aluminium and is painted in a non-reflecting manner. In this way, undesirable reflections, which may lead to scattered light, are prevented.

In the case of the present invention, the light-guiding unit is optionally fastened on a light source box by means of a mount.

The invention will be explained in greater detail hereinafter on the basis of an exemplary embodiment illustrated schematically in the drawing, in which:

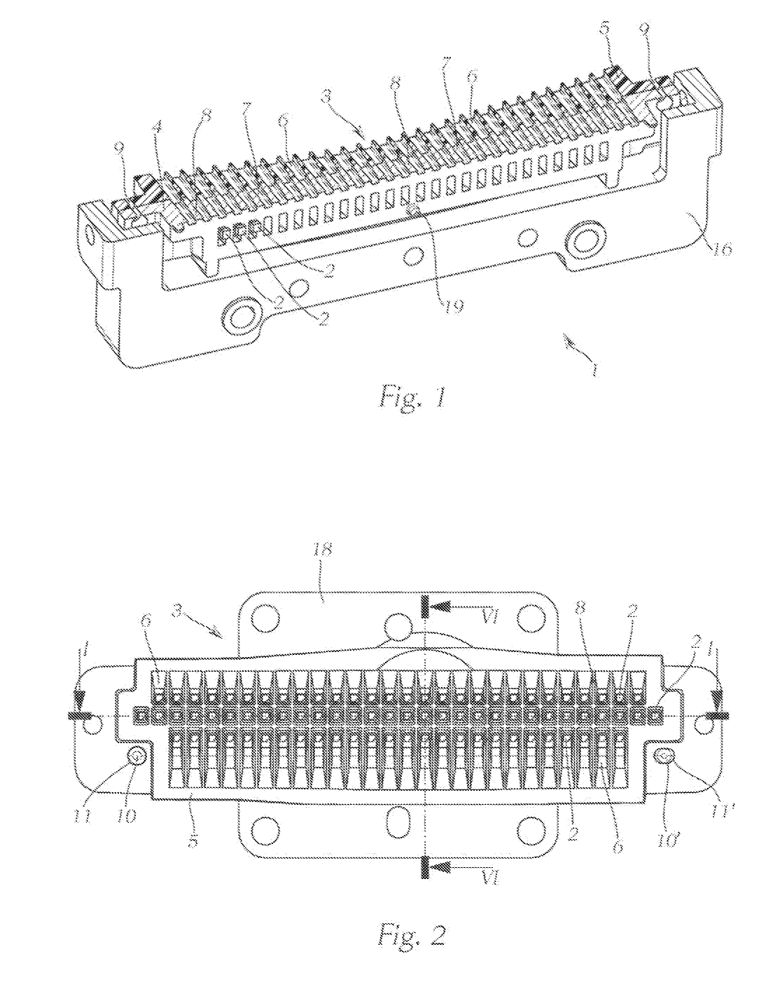

FIG. 1 shows a perspective sectional illustration of a lighting unit according to the invention in accordance with the line I-I of FIG. 2,

FIG. 2 shows a front view of a lighting unit according to the invention,

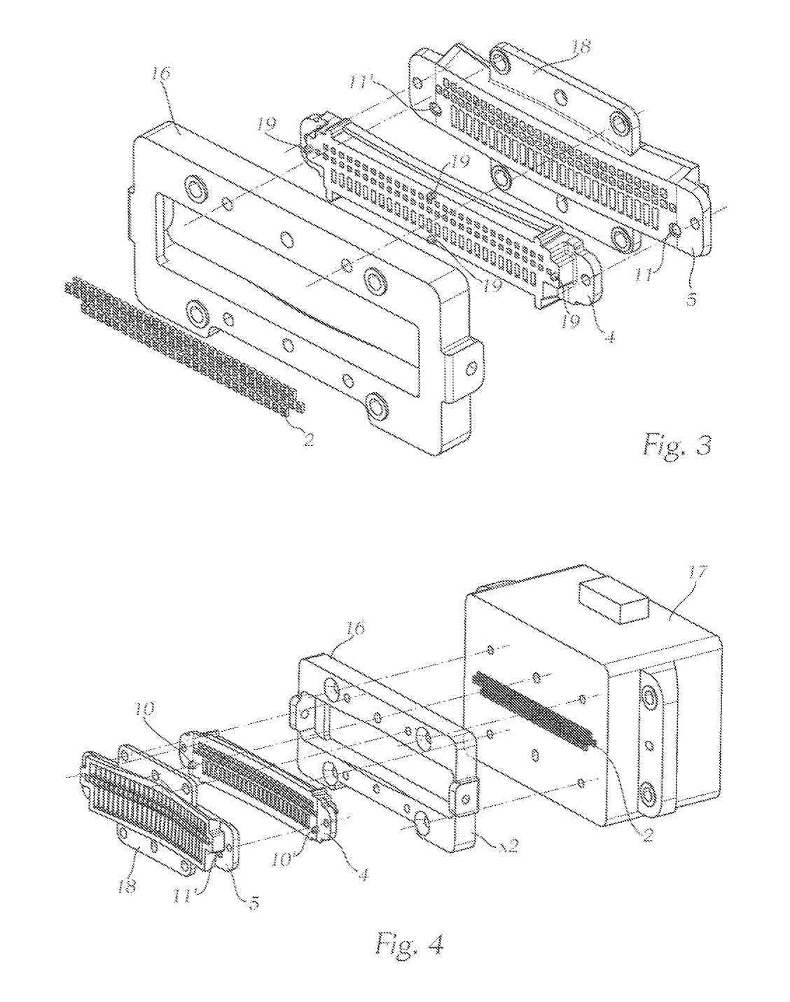

FIG. 3 shows an exploded view of a lighting unit according to the invention from the light source side,

FIG. 4 shows an exploded view of a lighting unit according to the invention in the situation of installation thereof on a light source box from the emission side,

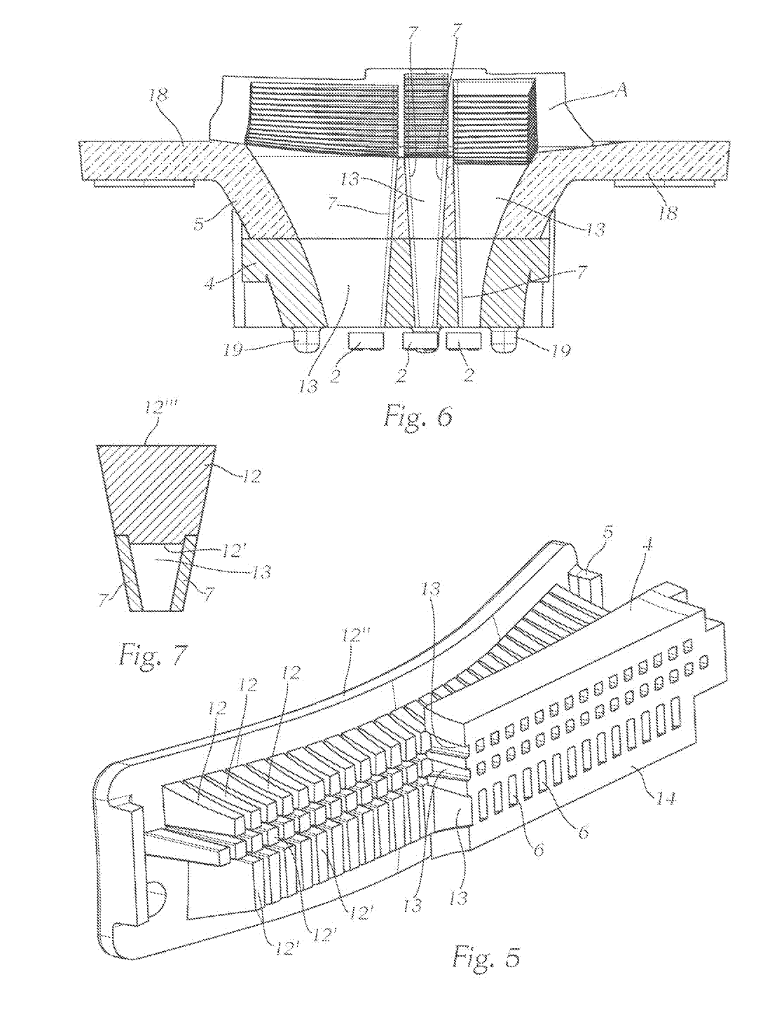

FIG. 5 shows a perspective view of a further embodiment of the lighting unit according to the invention partially in section,

FIG. 6 shows a vertical section through the lighting unit according to the invention in accordance with the line VI-VI of FIG. 2,

FIG. 7 shows a sectional illustration of a light guide in the sense of a variant of the present invention, and

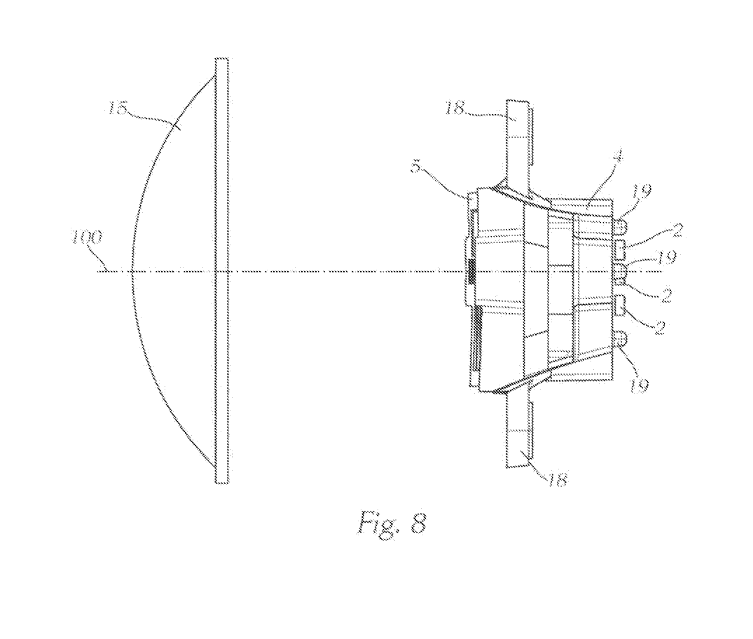

FIG. 8 shows a schematic side view of the lighting unit according to the invention and a lens assigned to said lighting unit.

In FIG. 1 a lighting unit according to the invention is denoted by 1. The lighting unit 1 consists substantially of a plurality of light sources 2 and a light-guiding unit 3. The light-guiding unit 3 is constructed in accordance with the invention such that a light-source-side part 4 of the light-guiding unit 3 is arranged between the light sources 2 and an emission-side part 5 of the light-guiding unit 3. Here, it is merely essential in accordance with the invention that a separate part 4 of the light-guiding unit 3 is provided, such that, besides the defined parts 4 and 5, further parts can also be provided, which together form the light guide. The light guides 6 are each assigned a light source 2, wherein the light guides 6 extend both in the light-source-side part 4 of the light-guiding unit 3 and in the emission-side part 5 of the light-guiding unit 3 or are formed thereby. The light sources 2 may each have one or more LED chips. In the illustration, only some of the light sources are illustrated, however it is clear that each light guide 6 is assigned a light source 2. The light guides 6 in the example according to FIG. 1 have reflector surfaces 7 coated with aluminium by means of vapour deposition. In FIG. 1 it can also be seen that the light sources 2 are arranged directly side by side, and therefore the reflector walls 8 must also be arranged adjacently to one another and therefore have very thin walls. The light-guiding unit 3 is constructed by being assembled and aligned by means of the fastening means 9. It is clear that practically any type of connection, in particular by latching, screwing or also adhesive bonding, of the two parts 4 and 5 of the light-guiding unit 3 may be expedient. Due to the divided structure of the light-guiding unit 3, a different material can be selected for the light-source-side part 4 of the light-guiding unit 3 compared with the material for the emission-side part 5 of the light-guiding unit 3. In particular, particularly heat-resistant plastics or other materials with high heat resistance are used for the light-source-side part 4, whereas, for the purpose of the reliable casting of the thin reflector walls 8, the emission-side part 5 can be produced from particularly flowable thermoplastics. The two parts 4, 5 of the light-guiding unit 3 are fastened in FIG. 1 to an optional mount 16 or are received therein, said mount being used to fasten the parts on a light source box 17 illustrated in FIG. 4. Reference numeral 19 denotes a spacer, which ensures a suitable spacing between the light-source-side part 4 of the light-guiding unit 3 and the light sources 2, which are arranged on the light source box 17. In FIG. 1 it can also be seen that the light-source-side part 4 of the light-guiding unit 3 and the emission-side part 5 of the light-guiding unit 3 are fastened, in the position thereof relative to one another, at curved surfaces corresponding to one another. This curvature follows the image field curvature of a lens 15, which is illustrated in FIG. 8.

In FIG. 2 like parts are denoted by like reference signs, wherein it can be seen that free cross sections are formed in the light-guiding unit 3 and form the light guides 6. In order to ensure that the two parts 4 and 5 of the light-guiding unit 3 are assembled so as to be flush and remain aligned with one another in a stable manner, even after a long period of operation, referencing pins 10, 10′ are provided, which cooperate with reference bores 11, 11′, which are formed as slots and are assigned to said referencing pins, as can be seen in particular also in the illustration according to FIGS. 3 and 4. The reference bore 11′ is formed in this example as a slot in order to compensate for thermal deformation of the parts 4 and 5. Reference sign 18 denotes a flange, which is also used for the fastening of the light-guiding unit 3.

In FIG. 3 spacers 19 can again be seen on the light-source-side part 4 of the lighting unit 3. Reference signs 11 and 11′ denote reference bores for receiving the referencing pins 10, 10′ illustrated in FIG. 4. A mount 16 can be provided optionally, which mount carries the light-guiding unit 3. In FIG. 4 the light source box 17 is also illustrated, on the outer side of which the light sources 2 are arranged in groups or in a matrix. The light source box 17 contains electronic circuits for actuating the individual light sources 2. The light source box can switch on and off individual light sources 2 and can also dim the light sources 2. It can also be deduced from FIG. 4 that the emission side of the light-guiding unit 3 is curved. This curvature follows the image field curvature of a lens 15, which is illustrated in FIG. 8.

FIG. 5 shows a variant of the invention, in which the emission-side part 5 of the lighting unit 3 has optical waveguides 12, which, together with the reflectors 13 assigned to the optical waveguides 12 in the light-source-side part 4, form the light guides 6. The optical waveguides 12 are combined on the emission side to form a common emission-side end plate 12″, which constitutes a common light decoupling surface of the individual light guides. The light-source-side surface 14 of the light-source-side part 4 of the light-guiding unit 3 is coated with aluminium by means of vapour deposition and is painted in a non-reflecting manner so as to prevent uncontrolled reflections, which may cause scattered light. In FIG. 5 it can also be seen that the light guides 6, in this case consisting of reflectors 13 and optical waveguides 12, are arranged in three rows arranged one above the other and can be activated by means of the light source box (17), which actuates the light sources 2, wherein the lighting functions of a headlight, such as a dipped beam, main beam, daytime running beam, etc., are implemented by appropriate switching of the rows. By way of example, all rows are switched on for main beam. By selectively switching off individual rows, further light distributions can be produced. The lower row is provided here for the main beam component, the middle row for the HD line region, and the upper row lights up the front end. The lighting functions are represented in a mirror-inverted manner in the light-guiding unit and are also represented in an inverted manner in the vertical direction, since the light image is completely reversed by the downstream lens discussed further below.

FIG. 6 illustrates a variant of the invention in which the reflectors 13 or reflector surfaces 7 extend in both parts 4 and 5 of the light-guiding unit 3. The light sources 2 radiate light into the assembled reflectors 13, which light is reflected at the reflector surfaces 7, coated with aluminium by vapour deposition, and is emitted in accordance with the geometry of the cross sections of the reflectors. The spacers 19 on the light-source-side part 4 of the light-guiding unit 3 are also illustrated, said spacers corresponding in terms of the extension thereof in the emission direction substantially to the dimensions of the light sources and thus defining a space, in which the light sources are arranged. Since the individual light guides 6 have different lengths and the light-guiding unit 3 consequently has a curved outer shape on the emission side, the end edges of further light guides 6 arranged behind the plane of section of FIG. 6 can be seen in the region denoted by A.

In FIG. 7 the cooperation of a reflector 13 and of an optical waveguide 12 according to FIG. 5 is illustrated more clearly. It can be seen that an optical waveguide 12 is fitted in an interlocking manner onto a reflector 13, such that the light-source-side end face 12′ of the optical waveguide directly adjoins the region of the coated reflector surfaces 7. The optical waveguide 12 preferably consists of a transparent plastic, which constitutes an optically denser medium compared with the air surrounding the optical waveguide 12, such that there is total reflection at the lateral interfaces of the optical waveguide 12. The light is additionally interrupted in the optically denser medium relative to the vertical and lastly is emitted at the emission-side end face 12′″ or light decoupling surface.

In FIG. 8 it is schematically illustrated that the lighting unit 1 according to the invention is assigned a lens 15, wherein an optical axis is denoted by 100 and intersects the lighting unit 1 for example at the height of the middle row of light guides 5.

1. A lighting unit for a headlight consisting of:
a plurality of light sources; and
a light-guiding unit having a plurality of light guides,
wherein:
each light guide is assigned a light source and the light-guiding unit consists of at least two interconnectable parts,
a light-source-side part of the light-guiding unit is arranged in the emission direction of the light-guiding unit between the light sources and an emission-side part of the light-guiding unit, and
the light-source side part of the light-guiding unit and the emission-side part of the light-guiding unit are fastened, in a position thereof relative to one another, at curved surfaces corresponding to one another.

2. The lighting unit of claim 1, wherein the light-source-side part of the light-guiding unit directly adjoins the light sources.

3. The lighting unit of claim 1, wherein the light-source-side part of the light-guiding unit is fabricated from a material that is more heat resistant than the emission-side part of the light-guiding unit.

4. The lighting unit of claim 1, wherein the emission-side part of the light-guiding unit is fabricated from a more flowable thermoplastic than the light-source-side part of the light-guiding unit.

5. The lighting unit of claim 1, wherein reflector surfaces of the light guides are coated with aluminium or another reflective material.

6. The lighting unit of claim 1, wherein the light-source-side part of the light-guiding unit and the emission-side part of the light-guiding unit have fastening means for fastening the two parts of the light-guiding unit transversely to the emission direction in the relative position of said two parts.

7. The lighting unit of claim 1, wherein the light-source-side part of the light-guiding unit has referencing pins and the emission-side part of the lighting unit has reference bores assigned to said referencing pins.

8. The lighting unit of claim 1, wherein the emission-side part of the light-guiding unit has a plurality of optical waveguides.

9. The lighting unit of claim 1, wherein the light-source-side part of the light-guiding unit has a plurality of optical waveguides.

10. The lighting unit of claim 8, wherein the optical waveguides are fabricated from a transparent plastic.

11. The lighting unit of claim 8, wherein each optical waveguide is assigned to a light guide.

12. The lighting unit of claim 8, wherein the optical waveguides have a stepped end region, which engages with corresponding reflectors.

13. The lighting unit of claim 11, wherein the optical waveguides assigned to the light guides are combined on the emission side in order to form a common emission-side end plate.

14. The lighting unit of claim 1, wherein a light-source-side surface of the light-source-side part of the light-guiding unit is coated with aluminium and is painted in a non-reflecting manner.

15. The lighting unit of claim 1, wherein the light-guiding unit is fastened on a light source box by means of a mount.

16. The lighting unit of claim 1, which is configured for a vehicle headlight.

17. The lighting unit of claim 9, wherein the optical waveguides are fabricated from a transparent plastic.

18. The lighting unit of claim 11, wherein the light guide is a reflector.
